(19) United States
(12) Patent Application Publication
(10) Pub. No.: US 2001/0052239 A1
(43) Pub. Date: Dec. 20, 2001

(54) Method and structure for the production of a semi-frozen beverage

(76) Inventor: Mark H. Dorner, Grand Junction, CO (US)

Correspondence Address: Sten Erik Hakanson, IMI Cornelius, Inc., One Cornelius Place, Anoka, MN, 55303-6234, US

(21) Appl. No.: 09/756,982

(22) Filed: Jan. 9, 2001

Related U.S. Application Data
(60) Provisional application No. 60/175,520, filed on Jan. 11, 2000.

(51) Int. Cl. A23G 9/00

(52) U.S. Cl. 62/342

(57) ABSTRACT

A freeze cylinder includes a scraper/mixing element having two rotating scraper mounting rods secured at opposite ends thereof to common spanning members. Each spanning member has a central pivoting mounting point for providing pivotal mounting thereof within the freeze cylinder. A scraper blade is secured to each of the scraper mounting rods. An eccentric shaft extends through the cylinder, offset from a central axis thereof and each end thereof extends is retained within a respective central pivoting mounting point of the spanning members. An auger section extends from one of the spanning sections for positioning thereof at a dispense end of the cylinder adjacent a dispensing valve. The scraper blade is used in the context of a semi frozen food product making and dispensing machine. In operation, a drive means provides for rotating the spanning members and hence the scraping blades and auger section within a food product producing freeze cylinder. The blades provide for harvesting semi-frozen food product from the interior surface of the freeze cylinder. As such are being rotated, the eccentric shaft remains motionless and offset form the central axis of the cylinder. Thus, as the drink is being formed, the eccentric shaft provides for additional mixing thereof as it is forced there against and made to flow there around. In this manner, better uniform drink viscosity consistency is provided for throughout the interior volume of the cylinder. When dispensing thereof is desired, the dispensing valve is opened and the rotation of the auger section insures that highly viscous food product is physically forced to and through the valve. The auger also provides for mixing of the food product and serves to move the semi-frozen drink to and through the valve in a manner that provides for uniform dispensing thereof.

### FIELD OF THE INVENTION

The present invention relates to semi-frozen beverage and food producing equipment, and in particulr to such equipment having a freeze cylinder with a scraping and mixing element rotating internally thereof.

### BACKGROUND

Equipment for producing and dispensing semi-frozen food products, such as, soft serve ice cream and slush ice drinks, is well known in the art. Typically, such food products are produced within a cylinder that is cooled by a mechanical refrigeration system. That system can include an evaporator wound around the exterior of the cylinder in close heat exchange contact there with. A scraper/mixing mechanism is rotatively mounted within the cylinder along the central axis thereof. Rotation of the scraper mechanism serves to remove a thin layer of the frozen food product from the interior surface of the cylinder gradually producing a semi-frozen or thickly viscous consistency thereof. In the case of slush ice type beverages, the viscosity is of particular concern, and various control strategies have been employed to maintain a predetermined chosen drink thickness.

In such equipment, fluid and/or gas pressure is relied upon to force the drink from the cylinder upon the opening of a dispense valve fluidly connected to the cylinder interior at a dispensing end thereof. However, problems have been encountered where a highly viscous drink is desired. Where the dispenser is set to produce a thick drink, there continues to be difficulties in maintaining a uniform drink consistency within essentially the entire interior volume of the cylinder. Where there is a less viscous fraction, that can be dispensed in preference to the more thick portion. As a result thereof, there can be an undesirable discontinuous dispense flow with attendant unwanted spattering and ejection of the drink from the valve. Thus, it would be highly desirable to have a semi-frozen food product dispenser wherein even very viscous products are dispensed smoothly and continuously.

### SUMMARY OF THE INVENTION

The present invention is described in the context of a frozen carbonated beverage dispenser. A freeze cylinder includes a unique scraper/mixing element having two rotating scraper mounting rods secured at opposite ends thereof to common spanning members. Each spanning member has a central pivoting mounting point for providing pivotal mounting thereof within the freeze cylinder to opposite ends thereof. A scraper blade is secured to each of the scraper mounting rods. An eccentric shaft extends through the cylinder offset from a central axis thereof and each end thereof extends through a respective central pivoting mounting point of the spanning members. An auger section extends from one of the spanning members for positioning thereof at a dispense end of the cylinder adjacent a dispensing valve.

In operation, a drive means provides for rotating the spanning members and hence the scraping blades and auger section. As such are being rotated, the eccentric shaft remains motionless and offset form the central axis of the cylinder. Thus, as the drink is being formed, the eccentric shaft provides for additional mixing thereof as it is forced there against and made to flow there around. In this manner, better uniform drink consistency is provided for throughout the interior volume of the cylinder. When dispensing thereof is desired, the dispensing valve is opened and the rotation of the auger section insures that even the most viscous drink product is physically forced to and through the valve. It can be appreciated by those of skill that the auger serves to move the semi-frozen drink in a manner that provides for uniform dispensing whereby any bridging thereof is prevented. Thus, the entire volume of drink at the dispense end of the cylinder is uniformly and consistently moved to the valve.

### DESCRIPTION OF THE DRAWINGS

A better understanding of the structure, and the objects and advantages of the present invention can be had by reference to the following detailed description which refers to the following figures, wherein:

FIG. 1 shows a perspective view of the scraper/mixing structure of the present invention.

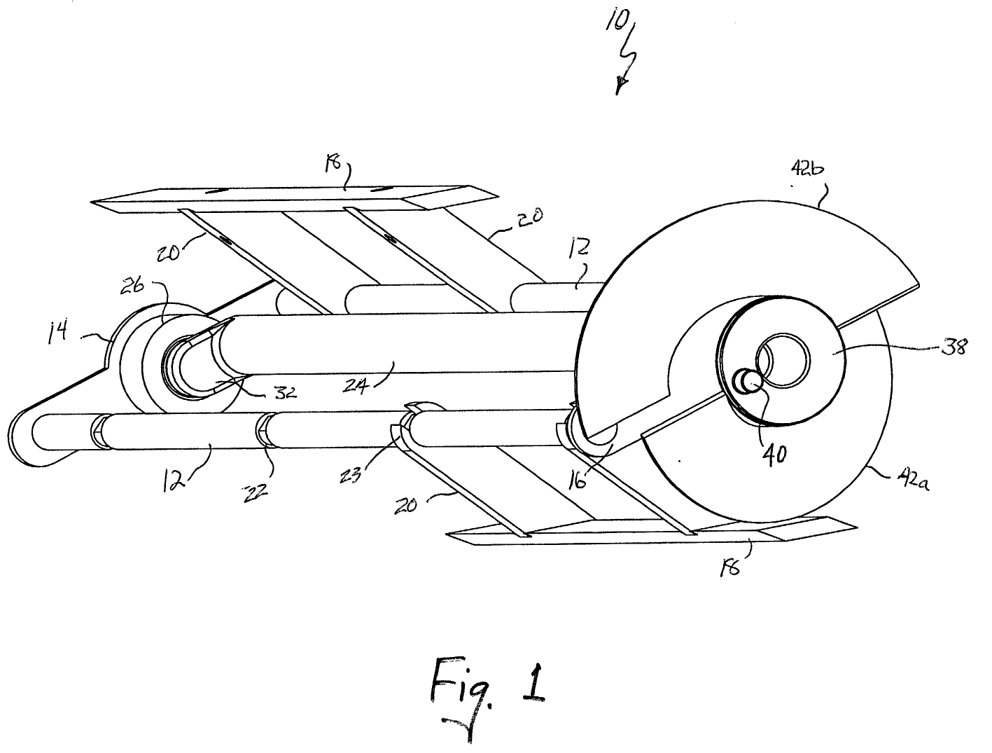

FIG. 2 shows a further opposite end orientation perspective view of the scraper/mixing structure of the present invention.

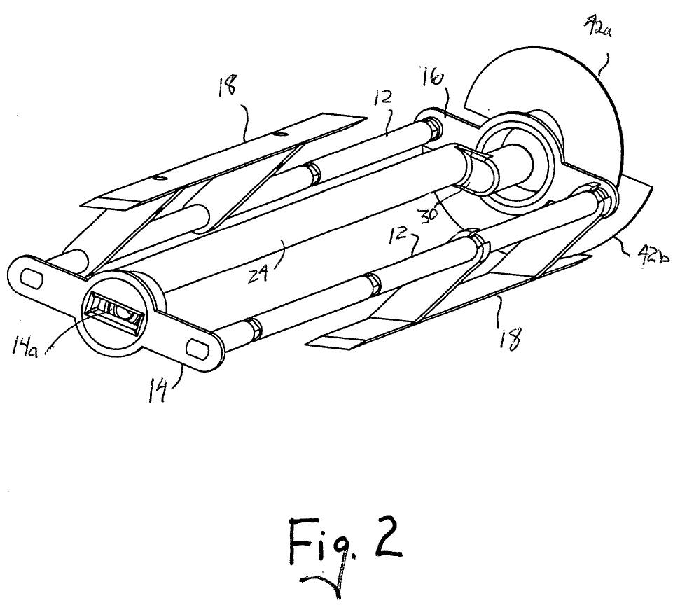

FIG. 3 shows a further perspective view of the present invention with the scraper blades and eccentric shaft removed.

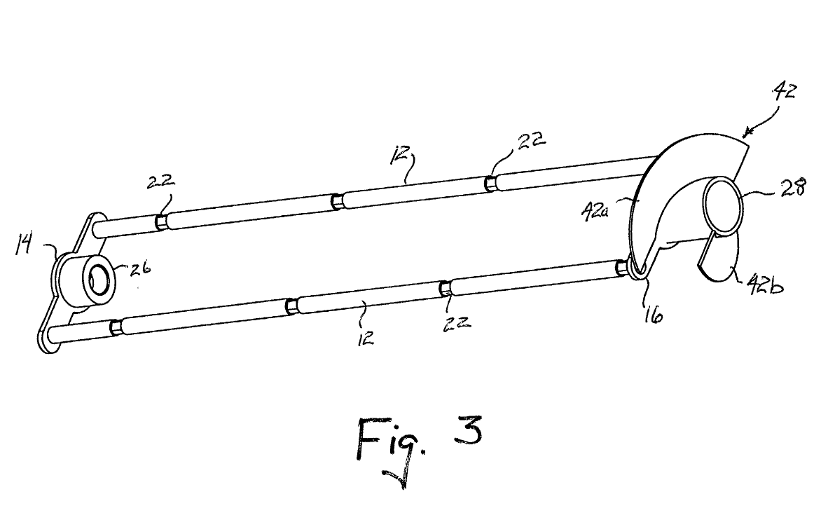

FIG. 4, shows a perspective view of the eccentric shaft structure of the present invention.

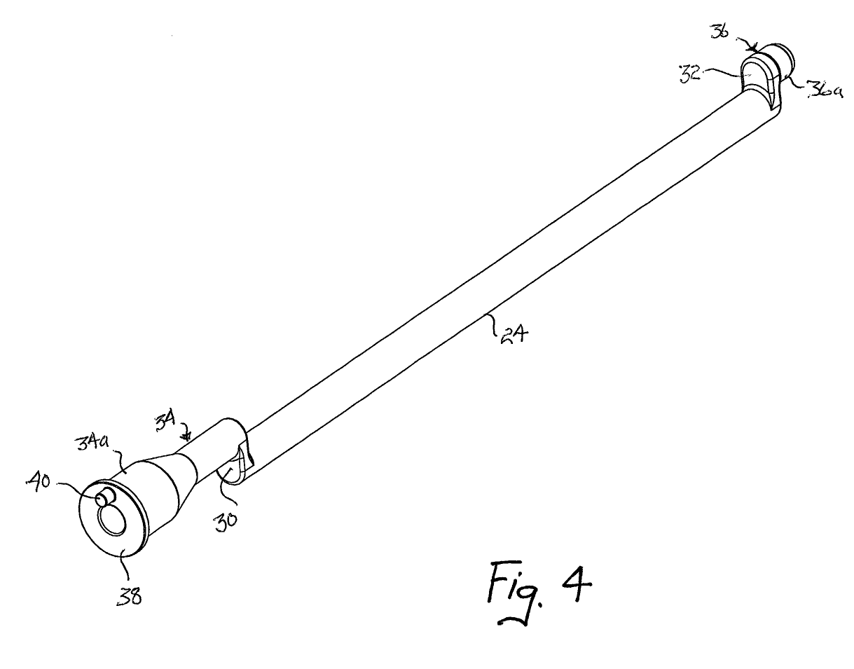

FIG. 5 shows an environmental perspective view of the present invention in the context of a freeze cylinder.

### DETAILED DESCRIPTION OF THE PREFERRED EMBODIMENT

The scraper/mixing mechanism of the present invention is seen in the various figures and generally referred to by the numeral 10. Scraper 10 includes a pair of mounting rods 12 fixedly secured to and extending between a rear spanning member 14 and a front spanning member 16. Member 14 includes a rotor shaft receiving drive slot 14a. A scraping blade 18 is secured to each rod 12 and spaced there from by extension arms 20. Rods 12 include annular recesses 22 for permitting releasable securing pivotal mounting of open ends 23 of arms 20 there with. An eccentric shaft 24 extends through central pivot housings 26 and 28 of spanning members 14 and 16, respectively. Shaft 24 includes two transverse offset portions 30 and 32 for connection thereof to corresponding axial shaft portions 34 and 36 respectively. Shaft portions 34 and 36 include bearing surfaces 34a and 36a around which pivot housings 26 and 28 rotate. Shaft portion 34 includes a circular end face 38 having a key 40 extending therefrom. A helical auger blade 42, comprised of two auger blade portions 42a and 42b, is secured to spanning member 16 and the exterior of housing 28.

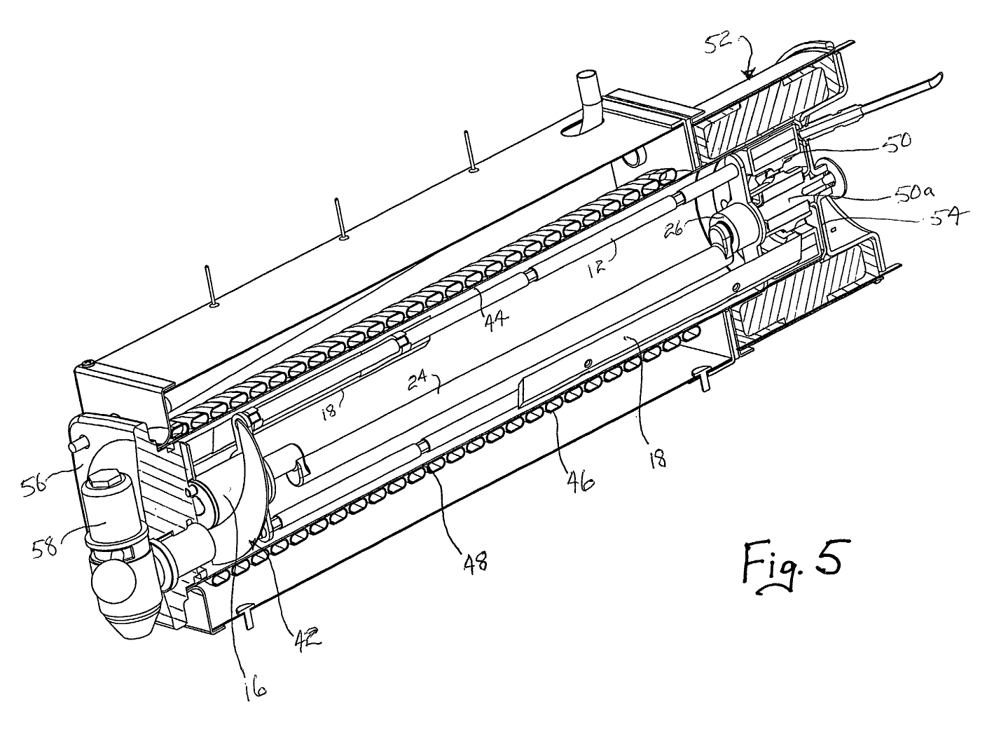

As is known in the art, scraper 10 is used in the context of a frozen food product machine, such as, a frozen carbonated beverage machine. As is also understood, and by referring to FIG. 5, scraper 10 is rotatively mounted within the interior of a freeze or slush producing cylinder 44 having an refrigeration evaporator 46 wrapped around and secured to an exterior surface 48 thereof. Rotation of scraper 10 is achieved by a drive mechanism. In the illustrated embodiment, a shaftless drive system is used. Such a drive mechanism is seen in co-pending U.S. patent application Ser. Nos. 08/987,395 and 09/079,683, the contents of which are incorporated herein by reference thereto. In particular, a magnetic rotor 50 is positioned within cylinder 44 and includes a central shaft 50a that extends into slot 14a for providing driving engagement with spanning member 14. Rotor 50 is rotated by a stator 52 secured around a end portion of cylinder 44. Those of skill will appreciate that a magnetic field is induced by stator 52 in a sequential manner thereby inducing rotation of rotor 50. Those of skill will also appreciate that a conventional shaft drive mechanism can also be used with the invention herein wherein a drive shaft extends through a cylinder end wall 54 and is secured to and drives spanning member 14. An end plate 56 is sealingly secured to the end of cylinder 44 opposite from the drive mechanism and a beverage dispensing valve 58 is secured thereto. End plate 56 includes a recess for receiving key 40.

In operation, it can be understood that rotation of rotor 50 rotates spanning member 14 and hence, rods 12, spanning member 16, auger 42 and scraping blades 18. Blades 18 are then positioned against the interior surface of cylinder 44 and provide for harvesting of frozen beverage there from. It can be understood that eccentric shaft 24 remains motionless and is offset from the central axis of cylinder 44. Thus, the slush beverage is moved against shaft 24 as a result of the rotation of blades 18, which action serves to enhance the mixing of the cylinder beverage contents. As is understood, when dispensing of the beverage is desired, valve 56 is opened to permit the beverage within cylinder 44 to flow there from into a suitable receptacle by force of fluid and/or gas pressure within cylinder 44. In addition thereto, it can be appreciated that auger blades 42 serves to force semifrozen beverage in a screw action against end plate 54 and through valve 56. Thus, even very viscous beverages can be positively moved out of cylinder 44 wherein no air gaps are formed therein. Therefore, such thick beverages can be dispensed in a continuous fashion without breaks therein so that any sputtering or the like is greatly reduced or eliminated. It can also be understood that the auger segment 42 serves to provide for an additional mixing action on the beverage. This results from the fact that scraper 10 is generally continuously rotated during, as well as between, each dispensing.

In the claims:

1. A scraper mechanism for use in a semi-frozen food product making and dispensing machine having a freeze cylinder for producing the semi-frozen food product therein and a dispensing valve secured to a front end of the cylinder and fluidly coupled with an interior volume of the cylinder, the scraper mechanism, comprising:
a pair of scraping blades secured to a rotating structure, the rotating structure rotatively mounted within the freeze cylinder interior volume for rotating around a central axis thereof, and the rotating structure including an eccentric shaft pivotally secured to either end of the freeze cylinder and extending there along and offset from the freeze cylinder central axis.

2. The scraper as defined in claim 1, and including an auger segment secured to the rotating structure for positioning thereof adjacent the cylinder front end for moving frozen food product in the direction of the dispensing valve.
